(19) United States
(12) Patent Application Publication
(10) Pub. No.: US 2007/0135945 A1
(43) Pub. Date: Jun. 14, 2007

(54) Identifying property relationships

(75) Inventor: Benjamin Philip Glenn, Seattle, WA (US)

Correspondence Address: WOODCOCK WASHBURN LLP (MICROSOFT CORPORATION), CIRA CENTRE, 12TH FLOOR, 2929 ARCH STREET, PHILADELPHIA, PA, 19104-2891, US

(73) Assignee: Microsoft Corporation, Redmond, WA (US)

(21) Appl. No.: 11/302,787

(22) Filed: Dec. 14, 2005

(51) Int. Cl. G05B 15/00

(52) U.S. Cl. 700/83

(57) ABSTRACT

The embodiments contemplate a system and method for identifying a relationship of a property by displaying properties of style sheets, selecting a property, and identifying related properties on related style sheets. The selected property may be chosen from style sheets or from an element, such as an object. Style sheets may be related to one another through an inheritance relationship, in which an inherited style sheet inherits the properties defined on an inheritor style sheet and also includes its own defined properties. The identification may be of an inheritor property, in which the inheritor property's style sheet is inherited to one or more style sheets defining the same property. The identification may also be that of an inherited property, where the inherited property's style sheet inherits a style sheet defining the same property. The identification may be a highlighting of the selected property and its related properties, or other mechanism.

### BACKGROUND

Property setters, such as font type, text color, and background color, are used extensively in computer languages to create and update documents and web pages, for example. Property setters may be grouped into predetermined collections known as style sheets. Style sheets may be applied to various objects, such as controls, including for example, menus and scroll bars. An object to which a style sheet is applied possesses the properties defined by the property setters in the style sheet. Style sheets are useful in developing and maintaining various documents and pages as pre-defined style sheets may be widely applied to various objects. Using for example hypertext markup language (HTML) or extensible markup language (XML), programmers and developers may create or maintain documents or web pages by simply and quickly choosing a style sheet for a desired visual effect for an object, rather than creating and setting the individually desired properties to create the same effect.

Moreover, multiple style sheets may form a cascading or hierarchical relationship where more than one style sheet may be applied to an object. If a style sheet forms a cascading relationship with one or more style sheets, the property setters in this cascaded relationship may be applied to the object. The cascaded network or relationship of style sheets proves to be particularly advantageous to programmers and developers as various cascaded relationships can easily be formed and applied to objects without creating and defining new style sheets with new property setters.

Often a programmer or developer may require diagnostic capabilities to determine and identify the resulting properties of an object, as applied from a style sheet. For example, a developer may apply a style sheet, which is part of a cascading relationship, to an object and wish to determine where and how a particular property was defined. Or a developer may be choosing between several style sheets for an object, and the identification of a property and its modification through and relationship with the cascaded network may assist in the developer's style sheet selection. Therefore, a capability for identifying property relationships of style sheets is desired.

### SUMMARY

The identification of a relationship of a property is achieved by displaying properties of style sheets, selecting a property, and identifying related properties on related style sheets. The selected property may be chosen from style sheets or from an element, such as a displayed object. Style sheets may be related to one another through an inheritance relationship, in which an inherited style sheet inherits the properties defined on an inheritor style sheet and also includes its own defined properties. The identification may be of an inheritor property, in which the inheritor property's style sheet is inherited by one or more style sheets defining the same property. The identification may also be that of an inherited property, where the inherited property's style sheet inherits from a style sheet defining the same property. The identification may be a highlighting or shading of the selected property and its related properties. The identification may also include the incorporation of different shadings, where the selected property is shaded in a color and the related properties are identified by a shading in a different shade of the color. Icons or diagrammatic markings may also be used for the identification.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

The foregoing summary and the following detailed description of the invention are better understood when read in conjunction with the appended drawings. Exemplary embodiments of the invention are shown in the drawings, however it is understood that the invention is not limited to the specific methods and instrumentalities depicted therein. In the drawings:

FIG. 1 is a is a block diagram representing an exemplary computing device in which the invention may be implemented;

FIG. 2 is a representation of a display of properties of style sheets, wherein a property relationship is identified;

FIG. 3 is a representation of a display of properties of style sheets, wherein a property relationship is identified;

FIG. 4 is a representation of a display of properties of style sheets and an element, wherein a property relationship is identified;

FIG. 5 is an additional representation of a display of properties of style sheets and an element, wherein a property relationship of a characteristic and properties is identified;

FIG. 6 is a representation of a display of properties of style sheets and an element, wherein a query list is displayed; and

FIG. 7 is a flow diagram illustrating one embodiment of a method of identifying a relationship of a selected property.

### DETAILED DESCRIPTION

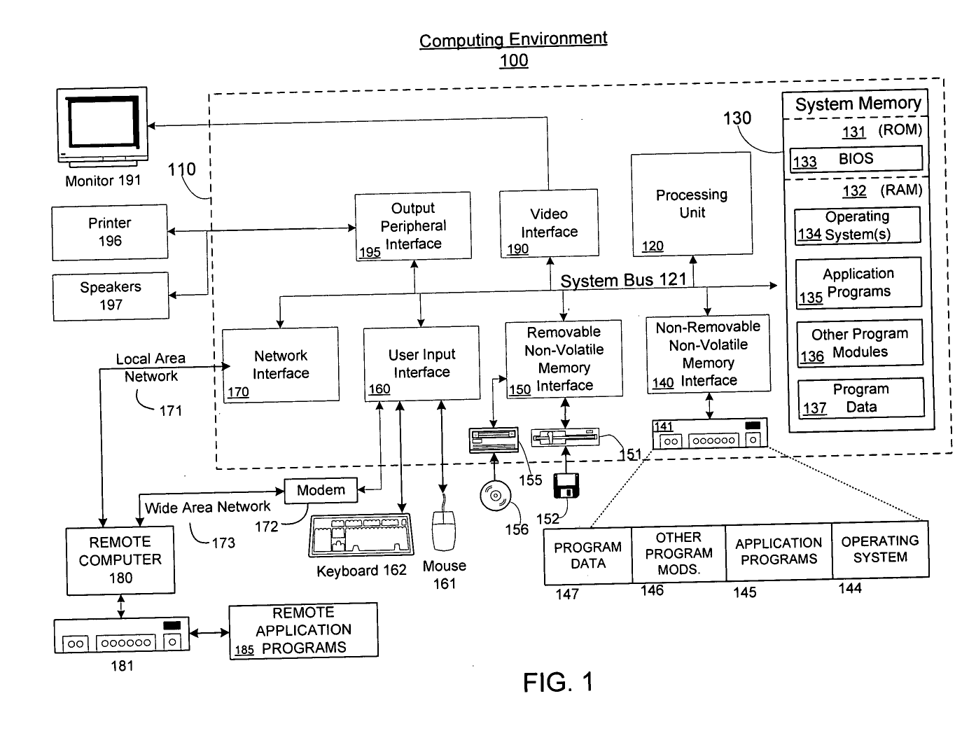

With reference to FIG. 1, an exemplary system for implementing the invention includes a general purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus (also known as Mezzanine bus).

The computer 110 typically includes a variety of computer readable media. Computer readable media can be any available media that can be accessed by the computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 130 includes computer storage media in the form of volatile and/or nonvolatile memory such as ROM 131 and RAM 132. A basic input/output system 133 (BIOS), containing the basic routines that help to transfer information between elements within the computer 110, such as during start-up, is typically stored in ROM 131. RAM 132 typically contains data and/or program modules that are immediately accessible to and/or presently being operated on by the processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156, such as a CD-ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as an interface 140, and the magnetic disk drive 151 and the optical disk drive 155 are typically connected to the system bus 121 by a removable memory interface, such as an interface 150.

The drives and their associated computer storage media, discussed above and illustrated in FIG. 1, provide storage of computer readable instructions, data structures, components, program modules and other data for the computer 110. In FIG. 1, for example, the hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 110 through input devices such as a keyboard 162 and a pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and a printer 196, which may be connected through an output peripheral interface 195.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

All or portions of the methods of the present invention described above may be embodied in hardware, software, or a combination of both. When embodied in software, the methods of the present invention, or certain aspects or portions thereof, may be embodied in the form of program code that when executed by a computing system cause the computing system to perform the methods of the present invention. This program code may be stored on any computer-readable medium, as that term is defined above.

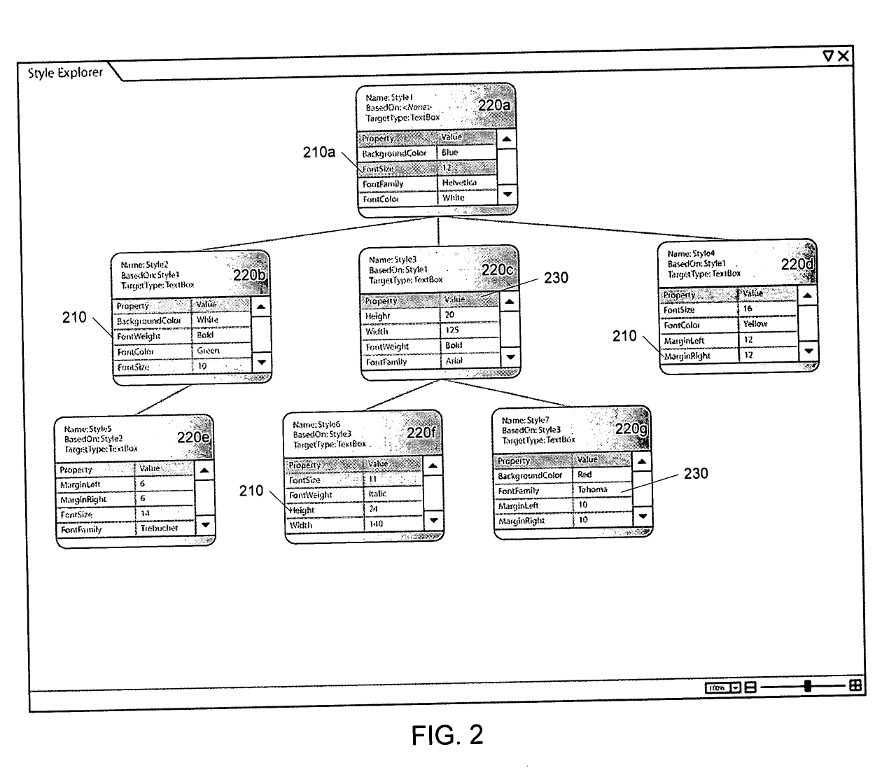

FIG. 2 is a representation of a display of properties 210 of style sheets 220. The display of the properties 210 is outputted on a display module, such as the monitor 191. The properties 210, such as font type and foreground color, include property setters 230, or values, to define each property 210. For example, a property setter 230 of the property 210 “background color” may be “yellow” or “purple.” The properties 210 and their setters 230 may be used to establish the appearance of documents or web pages. The properties 210 are grouped into style sheets 220. The style sheets 220 may be used to apply the properties 210 of that group to a certain object or element of a document. For example, the style sheet 220c may be selected and applied to a text box, resulting in the defined properties 210 of the style sheet 220c setting the appearance of the text box.

As shown in FIG. 2, the style sheets 220 may be arranged into relationships with one another. FIG. 2 illustrates a relationship of the style sheets 220a-220g; it is understood, however, that the invention is not limited to any particular number or arrangement of the style sheets 220. One such relationship that may be created is an inheritance relationship. For example, the style sheets 220b, 220c, and 220d may each inherit from the style sheet 220a, while the style sheet 220e may inherit from the style sheet 220b. In an inheritance relationship, the style sheet 220 that inherits includes its own defined property setters 230 as well as those of the style sheet 220 from which it inherits. For example, with reference to FIG. 2, an object to which the style sheet 220d is applied may contain the property setters 230 of both the style sheet 220d and the style sheet 220a.

According to a further embodiment, cascading relationships may also be created, as the style sheet 220 may inherit from previously created inherited relationships. For example, the style sheets 220a, 220c, and 220f may form a cascading relationship.

The invention is not limited to inheritance and cascading relationships. Other arrangements, such as the style sheets 220 arranged in a bottom-up relationship where the lower style sheet 220 may set the properties 210 of the higher style sheet 220, may exist. As a further arrangement example, the style sheets 220 may reference or include one or more of the style sheets 220.

The related style sheets 220, such as those in an inheritance relationship, may include a property 210 which was previously defined by an inheritor style sheet 220. For example with reference to FIG. 2, the style sheet 220e, which inherits from the style sheet 220b, and the style sheet 220b both define a property setter 230 for the property 210 “font size.” In one embodiment, the property setter 230 defined by the lower style sheet 220 (e.g. the style sheet 220e) may overwrite that as defined by the higher style sheet 220 (e.g. the style sheet 220b). In this embodiment, an object to which the style sheet 220e is applied may have the font size setting as defined in the style sheet 220e, and perhaps not the style sheet 220b. In another embodiment, exceptions may be created wherein the style sheet 220b overrules the style sheet 220e. In this example embodiment, an object to which the style sheet 220e is applied may have the font size setting as defined in the style sheet 220b rather than that defined in the style sheet 220e.

Identifying property relationships within a network of style sheets, such as the network of FIG. 2, is a desirable feature for trouble-shooting, as well as for design purposes. In one embodiment, a property 210 of a style sheet 220 may be selected with a selection module, for example, the keyboard 162 or mouse 161. This property 210 may be selected, for example, in order for a web designer to determine where the particular property 210 was defined in the style sheet network. In response to the selection of the property 210 the relationship of the selected property 210 may be displayed on the relevant style sheets 220. The relationship may be identified in a number of ways, such as by identifying the selected property 210 and any of the related properties 210. In one embodiment, the relationship of the selected property 210 is an inheritance from a property 210. In this embodiment, an inherited style sheet 220 may inherit from an inheritor style sheet 220 and define the selected property 210, where the same property 210 is defined differently in the inheritor style sheet 220.

In another embodiment, the relationship of the selected property 210 may be an inheritor to a property 210. In this embodiment, an inheritor style sheet 220 may define the selected property 210 and may inherit to an inherited style sheet 220, which defines the same property 210 as the selected property 210, although the inherited property 210 may be defined differently than the selected inheritor property 210. In yet another embodiment, the relationship of the selected property 210 may be both an inheritance from a property 210 and an inheritor to a property 210.

In one embodiment, identifying the selected property 210 and identifying any related properties 210 comprises highlighting the properties 210. In a further embodiment, the selected property 210 may be highlighted in a color, while the related properties 210 may be highlighted in a shade of this color to distinguish between the selected property 210 and its related properties 210.

FIG. 2 provides an illustration of the identification of a relationship of a selected property. In the style sheet 220a, the property 210 “font size” (denoted as the property 210a) may be selected in order to display its relationship. The property 210a is highlighted, as are the “font size” properties 210 that are defined in the style sheets 220 that inherit style sheet 220a. The style sheets 220b, 220d, 220e, and 220f, which either directly or indirectly inherit from the style sheet 220a, include a property setter 230 (different then the property setter 230 for the selected property 210a) for the property 210 “font size,” and are accordingly highlighted to show the existence of a relationship with the selected property 210a. In an example embodiment, the related properties 210 are highlighted in a different shade than the selected property 210a to distinguish between the selected property 210 and its related properties 210.

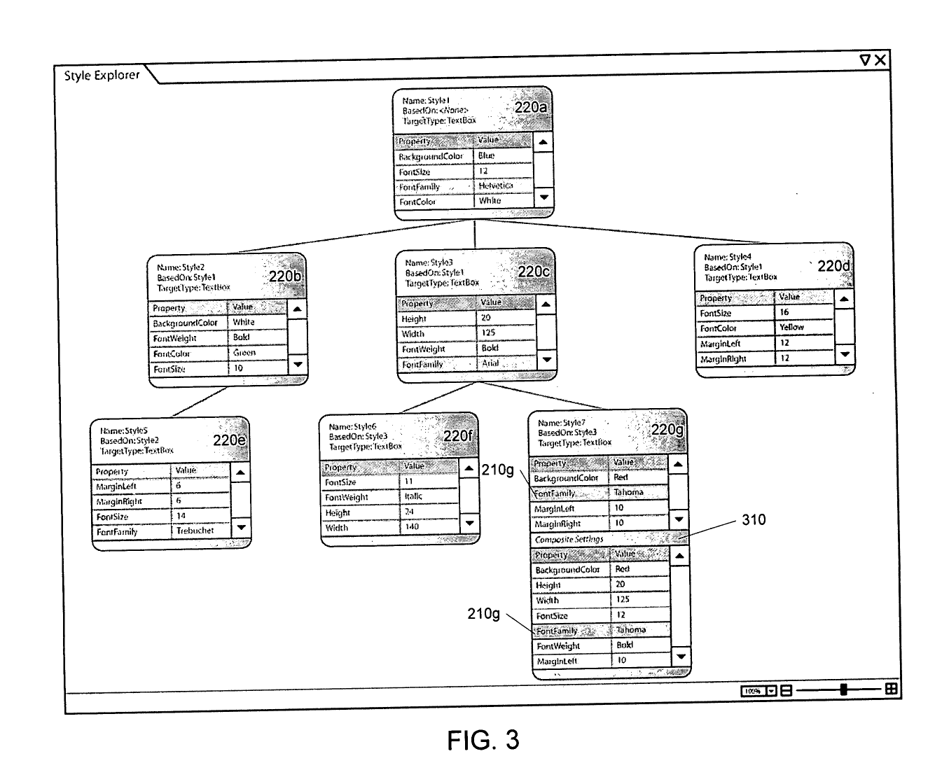

FIG. 3 provides a further illustration of the identification of a relationship of a selected property 210. In this example embodiment, the property 210g (“font family”) is the selected property 21Og from the style sheet 220g. The relationship of the selected property 210 is an inheritance from a property 210; in the example shown in FIG. 3, the property 210g is inherited from the “font family” property 210 as defined on the style sheet 220c. In addition, the “font family” property 210 as defined on the style sheet 220c is inherited from the “font family” property 210 as defined on the style sheet 220a. Accordingly, a cascading relationship is created including the style sheets 220a, 220c, and 220g.

The related properties 210 may be identified, according to an embodiment of the invention, by highlighting or shading the related properties 210. In addition and according to a further embodiment of the invention, the selected property 210g may be highlighted in a different (i.e. lighter or darker) shade than its related properties on the style sheets 220a and 220c.

The identification through the use of highlighting and shading is not meant to limit the invention to only this type of identification. Rather, it is envisioned that other identification approaches, are possible in accordance with the invention. Some examples of other identification approaches include flashing the related and selected properties; displaying icons next to or near the related and selected properties; and applying diagrammatic markings, such as arrows and lines, to the related and selected properties.

In one embodiment, an aggregate or composite listing of the selected property 210 may be displayed, as illustrated on FIG. 3. As described above, when a style sheet 220 inherits from another style sheet 220, the properties 210 defined in both of the style sheets (i.e. the inheritor and the inherited) may be part of the inherited style sheet 220. This feature may be displayed, in accordance with an embodiment of the invention, as a composite setting 310. As an example and with reference to FIG. 3, the composite setting 310 for the style sheet 220g includes the properties 210 from the style sheets 220a, 220c, and 220g because the style sheet 220c inherits from the style sheet 220a, and the style sheet 220g inherits from the style sheet 220c. The selected property, in this example the property 210g, is identified in both the composite setting 310 of the style sheet 220g as well as the style sheet 220g. The relationship of the selected property 210 on the style sheets 220 may be identified on the composite setting 310. The identification of the selected property 210 in the composite setting 310 may match the identification of the property 210 in the style sheet 220 in which the property 210 was defined. For example, the property 210g is last defined in the style sheet 220g; therefore, the property 210g is identified by the same highlighting shade in the style sheet 220g and the composite setting 310. If, for example, the property 210g is last defined in the style sheet 220c, then the property 210g may be identified by the same highlighting shade in the style sheet 220c and the composite setting 310.

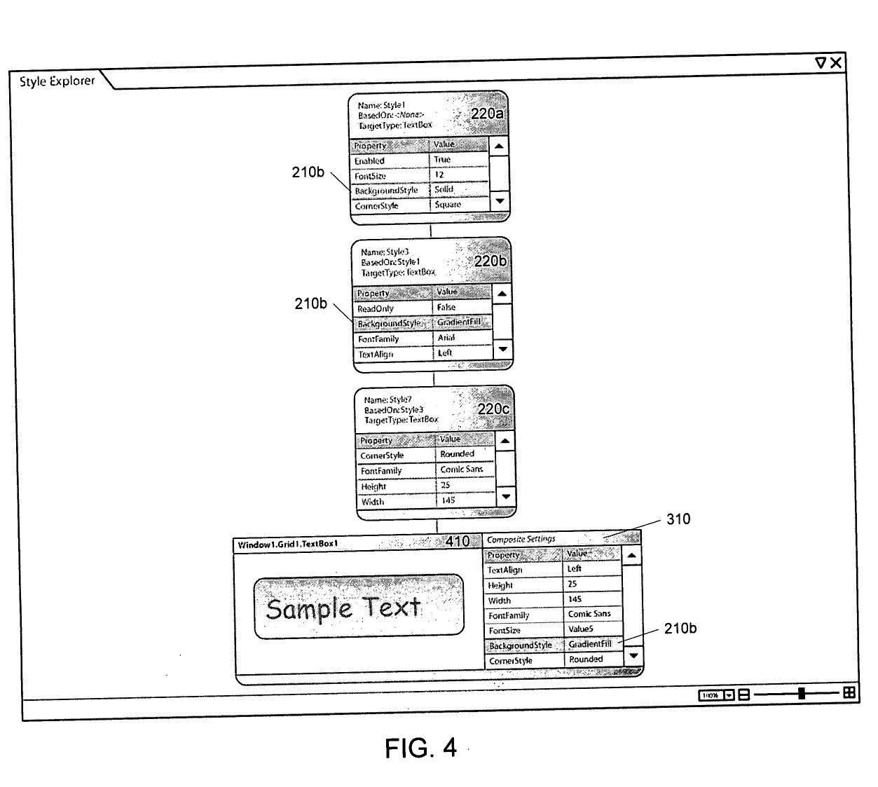

FIG. 4 illustrates a further embodiment, in which an element 410, such as a control (e.g. text box or pull-down menu) is displayed. A characteristic of the element 410 may be selected, and a relationship of a style sheet property 210 to the selected characteristic may be identified. In FIG. 4 an element 410 is displayed. If a characteristic of the element 410 is selected, for example in order for a designer to pinpoint where and how the characteristic was defined, a relationship between the selected characteristic of the element 410 and a style sheet property 210, where the style sheet property 210 contributes to the characteristic, may be identified. In the example embodiment of FIG. 4, the style sheet 220c is applied to the element (i.e. control) 410. The selected characteristic is the “background style.” The relationship is identified by the identification of the property 210b in the style sheets 220b and 220a. The property 210b defines, and hence contributes to, the selected characteristic, in this case the “background style.” In an embodiment, the property 210b may be identified through highlighting the property 210b. In another embodiment, the property 210b in the style sheet 220b may be highlighted in a different color than the property 210b in the style sheet 220a as the style sheet 220b defines the final property value as displayed on the element 410.

The property 210 that is associated with the element 410 is illustrated. This may be done, for example, by the composite setting 310. As shown in FIG. 4, the composite setting 310 that is associated with the element 410 may be identified. The composite setting 310 comprises the properties 210 that are applied to the element 410. In the example shown, the composite setting 310 includes the style sheets 220a, 220b, and 220c. In an embodiment, the relationship of the style sheet property 210 to the selected characteristic may be additionally identified in the composite setting 310.

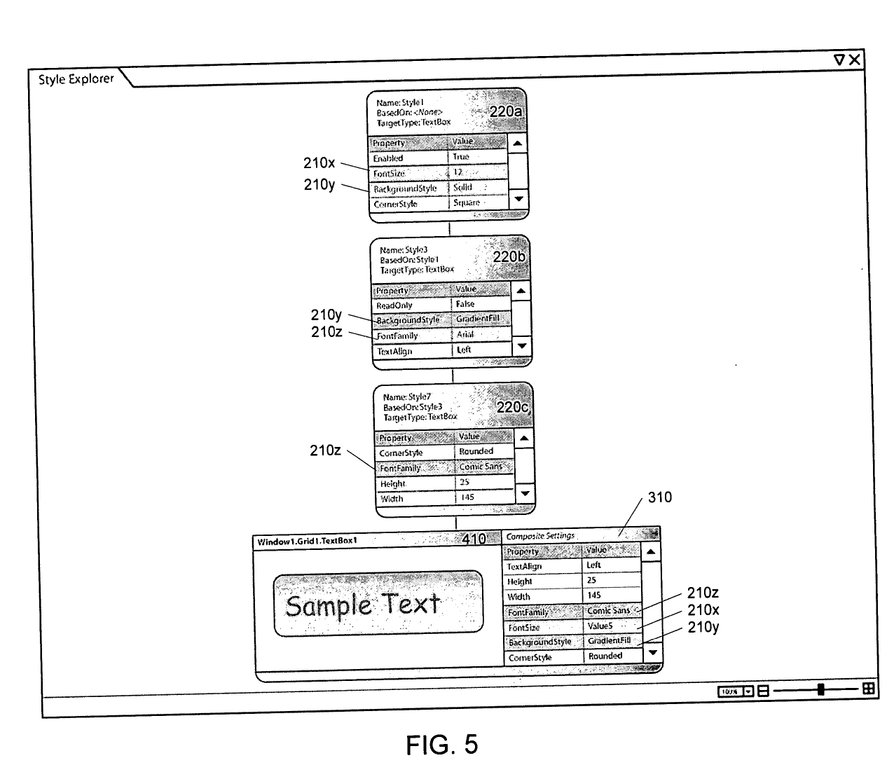

FIG. 5 is an extension of the embodiment shown in FIG. 4. In some situations, more than one property 210 may contribute to a selected characteristic of the element 410. For example, a background may be selected, where the contributing properties 210 may include “background color,” “background style,” and “background type.” In such a situation, one embodiment allows for the identification of a relationship of the multiple contributing properties 210 and the selected characteristic. This embodiment may be better understood with reference to FIG. 5.

In FIG. 5, a characteristic has been chosen; the properties 210x, 210y, and 210z contribute to this characteristic. According to an embodiment of the invention, the properties 210x, 210y, and 210z may be identified, by for example highlighting or shading, in their respective style sheets 220. The property 210z is defined in both the style sheets 220b and 220c; accordingly, both instances of the property 210z are identified. According to an aspect of the invention, the property 210z in the style sheet 220c may be highlighted in a different shade than the property 210z in the style sheet 220b. According to a further embodiment, the composite setting 310 for the element 410 is displayed. On this composite setting 310, the contributing properties 210x, 210y, and 210z are identified as contributing to the selected characteristic.

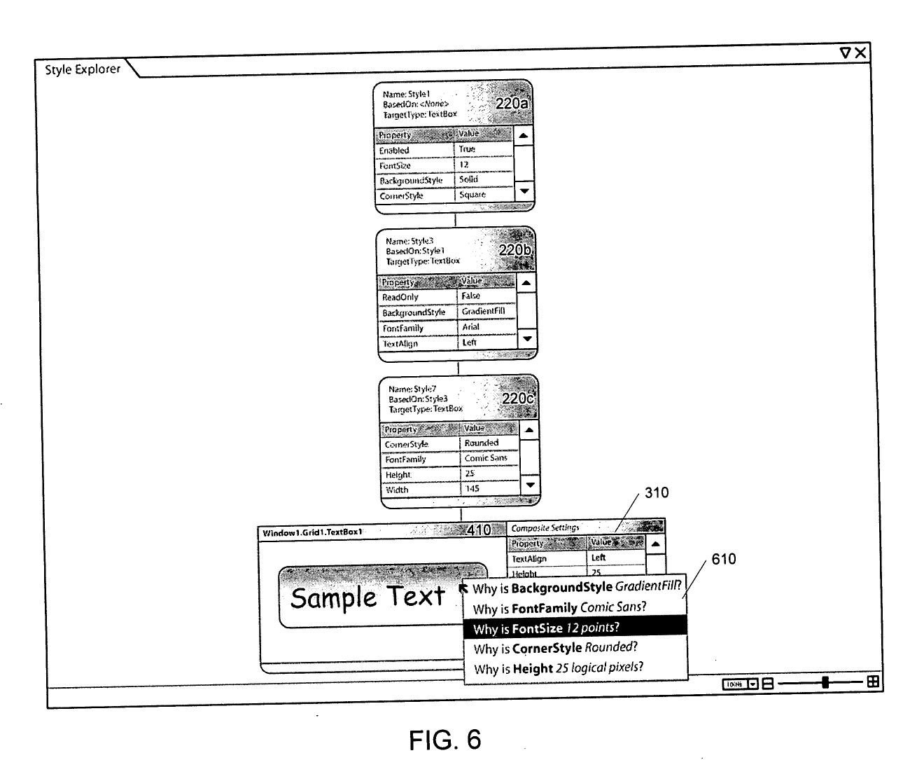

FIG. 6 illustrates a querying feature embodiment. A characteristic of the element 410 may be selected, resulting in a query list 610 being displayed, as shown on FIG. 6. The query list 610 may include questions relating to the selected characteristic and may provide a useful and straightforward diagnostic tool. For example, the query list 610 may include questions relating to the selected background characteristic, such as “why is background blue?” and “why is background style gradient fill?”. Once a question is selected from the query list 610, a reply may be generated in, for example, a text box (not shown). The reply may include the style sheet 220 and the property 210, as well as other relevant information, that led to the setting of the particular characteristic. Alternatively, the reply may include the highlighting of the relevant property setters that led to the setting of the selected and queried characteristic.

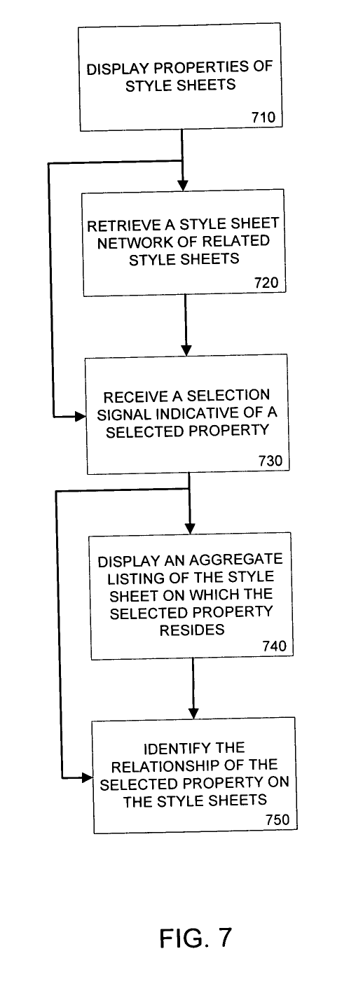

FIG. 7 illustrates an embodiment of a method of identifying a relationship of the selected property 210 in accordance with the present invention. Referring to FIG. 7, at step 710 the properties 210 of the style sheets 220 are displayed. The method may progress from step 710 to step 720 or to step 730. At step 720, a style sheet network of the related style sheets 220, such as the network shown in FIG. 2, is received. At step 730, a selection signal indicative of a selected property 210 is received. At step 740, an aggregate listing (such as composite setting 310) of the style sheet 220 on which the selected property 210 resides is displayed. Proceeding from step 730 or step 740, at step 750, in response to the selection signal, the relationship of the selected property 210 is identified on the style sheets 220.

As can be appreciated, the disclosed embodiments may be implemented as a whole or in part in one or more computing systems or devices. FIG. 1 illustrates the functional components of one example of a computing system 100 in which aspects of the present invention may be embodied or practiced. As used herein, the terms “computing system,” “computer system,” and “computer” refer to any machine, system or device that comprises a processor capable of executing or otherwise processing program code and/or data. Examples of computing systems include, without any intended limitation, personal computers (PCs), minicomputers, mainframe computers, thin clients, network PCs, servers, workstations, laptop computers, hand-held computers, programmable consumer electronics, multimedia consoles, game consoles, satellite receivers, set-top boxes, automated teller machines, arcade games, mobile telephones, personal digital assistants (PDAs) and any other processor-based system or machine. The terms “program code” and “code” refer to any set of instructions that are executed or otherwise processed by a processor. Program code and/or data can be implemented in the form of routines, programs, objects, modules, data structures and the like that perform particular functions.

It is noted that the foregoing examples have been provided merely for the purpose of explanation and are in no way to be construed as limiting of the present invention. While the invention has been described with reference to various embodiments, it is understood that the words which have been used herein are words of description and illustration, rather than words of limitation. The invention and various embodiments have been described with reference to style sheets, but the invention can equally apply to, for example, groups of settings used as editing features in a word processing environment or a web design application. Further, although the invention has been described herein with reference to particular means, materials and embodiments, the invention is not intended to be limited to the particulars disclosed herein; rather, the invention extends to all functionally equivalent structures, methods and uses, such as are within the scope of the appended claims.

What is claimed:

1. In a computer system, a method of identifying a relationship of a selected property, the method comprising:
displaying style sheets comprising properties;
receiving a selection signal indicative of a selected property; and
in response to the selection signal, identifying the relationship of the selected property on the style sheets.

2. The method of claim 1, wherein the relationship of the selected property is at least one of the following: an inheritance from a property and an inheritor to a property.

3. The method of claim 1, wherein identifying the relationship of the selected property on the style sheets comprises identifying the selected property and related properties.

4. The method of claim 3, wherein identifying the selected property and related properties comprises highlighting the selected property and highlighting related properties.

5. The method of claim 1, further comprising retrieving a style sheet network comprised of related style sheets, wherein each style sheet comprises properties.

6. The method of claim 1, further comprising: receiving a query signal indicative of a selected query, and providing information related to the relationship of the selected property.

7. The method of claim 1, further comprising displaying an aggregate listing of properties.

8. A computer-readable medium having computer-executable modules for illustrating properties contributing to a characteristic of a displayed element, comprising:
a display module for outputting a display of elements;
a selection module for processing the selection of a characteristic of an element; and
a relationship module for identifying a relationship of a style sheet property to the selected characteristic of the element.

9. The computer-readable medium of claim 8, further comprising a property module for illustrating a property associated with the element, wherein the property module identifies a style sheet property that contributes to the selected characteristic of the element.

10. The computer-readable medium of claim 8, wherein the element is a control.

11. The computer-readable medium of claim 8, wherein the characteristic comprises one or more properties.

12. The computer-readable medium of claim 8, wherein the relationship of the style sheet property to the selected characteristic of the element is at least one of the following: an inheritance from a property and an inheritor to a property.

13. The computer-readable medium of claim 8, wherein identifying a relationship of the contributing style sheet property to the selected characteristic of the element comprises highlighting the contributing style sheet property and highlighting related properties.

14. The computer-readable medium of claim 13, wherein highlighting related properties comprises highlighting related properties in a different shade than the highlighted contributing style sheet property.

15. A graphical user interface, comprising:
a window for displaying style sheets comprising properties;
a property identifier for providing an identification of a selected property on a style sheet; and
a relationship identifier for identifying a relationship of the selected property.

16. The graphical user interface of claim 15, wherein the style sheets are displayed cascading.

17. The graphical user interface of claim 15, wherein the style sheets are displayed hierarchically.

18. The graphical user interface of claim 15, wherein the identification of the relationship of the selected property on the style sheets comprises an identification of the selected property and related properties.

19. The graphical user interface of claim 15, wherein the relationship of the selected property is at least one of the following: an inheritance from a property and an inheritor to a property.

20. The graphical user interface of claim 15, further comprising an aggregate listing of properties.
